(19) United States
(12) Patent Application Publication
(10) Pub. No.: US 2009/0119702 A1
(43) Pub. Date: May 7, 2009

(54) ADVERTISEMENT AND CONTENT DISTRIBUTION

(75) Inventors: RAJESH JAGANNATHAN, PLANO, TX (US); RANDALL B. SHARPE, CHAPEL HILL, NC (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL LUCENT, Paris (FR)

(21) Appl. No.: 11/935,666

(22) Filed: Nov. 6, 2007

(51) Int. Cl. H04N 7/10

(52) U.S. Cl. 725/32

(57) ABSTRACT

A method, a computer readable medium and a system for advertisement and content distribution, comprises a splicer, and a set top box (STB), wherein the splicer is communicably coupled to the STB, wherein the splicer receives content, wherein the splicer receives at least one advertisement, wherein the splicer synchronizes the at least one advertisement on a first address with a slot in the content on a second address to produce an output, wherein the splicer sends the output to the STB, and wherein the STB displays the output.

### CROSS REFERENCE TO RELATED APPLICATIONS

The present patent application is related to and claims the benefit and priority of U.S. patent application No. 60/744,698 attorney docket no. 139503P, entitled “Customer Premises Equipment (CPE) Based Ad-Insertion Mechanism for IP Delivery Based Networks,” filed Apr. 12, 2006, the entire contents of which is incorporated by reference herein.

### FIELD OF THE INVENTION

The present invention is generally related to advertisement insertion, and more particularly to the advertisement and content distribution in Internet Protocol Television (IPTV) networks. In other embodiments, other networks can be utilized with the present invention.

### BACKGROUND OF THE INVENTION

Traditionally, targeted advertisement insertion in networks depends on the advertisement being delivered to a Set Top Box (STB). The STB is a device that connects to a television and an external signal source which turns the signal into content. This content is then displayed on a television screen. In one traditional solution, multiple content streams are sent concurrently from a source all the way to the STB. The STB can also tune into a channel carrying a target advertisement. In the traditional solution, multi-interest, multi-segment content (for example, news) can be achieved using known solutions such as video-on-demand, implying unicasting. There is no known solution for the multicasting of targeted advertisement. Therefore, what is needed is an ability to overcome the problems and limitations associated with distributing targeted advertisements to an end user.

Advertisement insertion in traditional solutions is often based on Society of Cable Telecommunications Engineers (SCTE) 35 and SCTE 30 signaling that was developed for the Cable TV industry. These solutions often provide limited targeting capability such as to a region, city or serving area constrained by the construction of the distribution network. If addressability is to be achieved for finer granularity such as to a neighborhood or household, then the insertion has to occur before transmission capacity is dedicated to the serving area. Such a solution does not scale well. These solutions that offer a STB providing advertisement insertion use a different mechanism than the ones offering traditional network based insertion. Therefore, two different mechanisms are required: live content distribution and STB stored advertisement insertion. Moreover, complex synchronization and insertion functions are required to be located in the STB thus leading to bandwidth inefficiently as the content is transported all the way to the STB even if it is not used by the STB. Such a scenario leads to last mile bandwidth constraints.

Therefore, what is needed is a mechanism that overcomes these problems and limitations.

### SUMMARY OF THE INVENTION

The present invention provides a system, method, and computer readable medium that efficiently distributes content and advertisements in real-time or at a point in time (for example when the advertisement is stored).

The present invention provides a mechanism that utilizes functionality already available in network based advertisement (Ad) splicers, and multicasting capabilities of an Internet Protocol Television (IPTV) network. Ad splicers synchronize the play of one or more ads to coincide with an ad slot in a broadcast video stream (or content). Normally the ad splicers substitute the ad for the broadcast stream during the ad slot. The stream leaving the ad splicer is available to all viewers in the serving area with a common ad.

In the present invention, however, the ad splicer synchronizes the play of one or more ads but does not splice. The broadcast stream with an empty ad slot is available to all viewers (and necessary equipment) having selected that stream. The synchronized ad streams are transmitted by the ad splicer and made available to viewers. STBs are made aware of the imminent ad slot using mechanisms specified in SCTE 35 signaling and based on viewer profile, interest, or other criteria. In one embodiment, other mechanisms and criteria can be used without departing from the scope of the present invention. Based on these mechanisms and criteria, one of the available ad streams is joined. The splice is made in the STB using streams selected by the STB. If the ad stream is already synchronized, no additional effort is expected at the STB other than a routine playing function from the incoming buffer. In other embodiments, the splicer may splice received data and the STB may synchronize received data.

In the present invention, the above described distribution and insertion mechanism could be used to distribute and store advertisements in a storage capable STB for non real-time distribution. As such, the transport capacity or splicer capacity can be minimized by transporting the advertisements to local storage during lean network usage times.

In an embodiment of the present invention, a flash memory (or other memory) is provided in an intermediate network element. For example, a Residential Gateway (RGW) can be provided that hosts an advertisement stream storage and addresses an Internet Group Management Protocol (IGMP) join and leave (for example, from an STB). A similar mechanism could be used in creating a personalized content service (for example, relating to news) with different modules corresponding to ad slots assembled on demand at the STB but synchronized at the splicer. The signaling may or may not be SCTE 35 based. The same insertion method can be used in a Picture-in-Picture mechanism as well as in other mechanisms.

The present invention should not be confused with a channel change to an ad channel as the STB continues to be connected to the program channel before, during, and after the ad. The ad stream can be joined before the ad begins and the STB can leave the stream well after the ad ends thereby reducing the peak processing load (such as the IGMP processing load) on an Access Node. Since the program stream does not carry traffic during the ad and the ad stream carries traffic only during the ad slot, the combined traffic level to the STB is the same as for a conventional solution.

In one embodiment of the disclosure, a system for advertisement and content distribution, comprises a splicer, and a set top box (STB), wherein the splicer is communicably coupled to the STB, wherein the splicer receives content, wherein the splicer receives at least one advertisement, wherein the splicer synchronizes the at least one advertisement on a first address with a slot in the content on a second address to produce an output, wherein the splicer sends the output to the STB, and wherein the STB displays the output.

In another embodiment of the disclosure, a method for distributing an advertisement and content, comprising receiving a content stream on a first channel, wherein the content includes an empty slot, sending a message, receiving a specific advertisement on the second channel based on the message, decoding the received content and the received specific advertisement, and displaying the decoded content and advertisement.

In a further embodiment of the disclosure, a computer readable medium comprises instructions for: receiving at least one advertisement on a first channel, receiving a content stream on a second channel, and synchronizing the at least one advertisement with an empty slot in the content stream.

### BRIEF DESCRIPTION OF THE DRAWINGS

FIG. 1 represents a block diagram depicting a system in accordance with an embodiment of the embodiment of the disclosure;

FIG. 2 represents a further block diagram depicting a system in accordance with an embodiment of the embodiment of the disclosure;

FIG. 3 represents a graphical user interface (GUI) in accordance with an embodiment of the embodiment of the disclosure;

FIG. 4 represents a flowchart in accordance with an embodiment of the embodiment of the disclosure;

FIG. 5 represents a further flowchart in accordance with an embodiment of the embodiment of the disclosure; and

FIG. 6 represents another system in accordance with an embodiment of the embodiment of the disclosure.

### DETAILED DESCRIPTION OF THE INVENTION

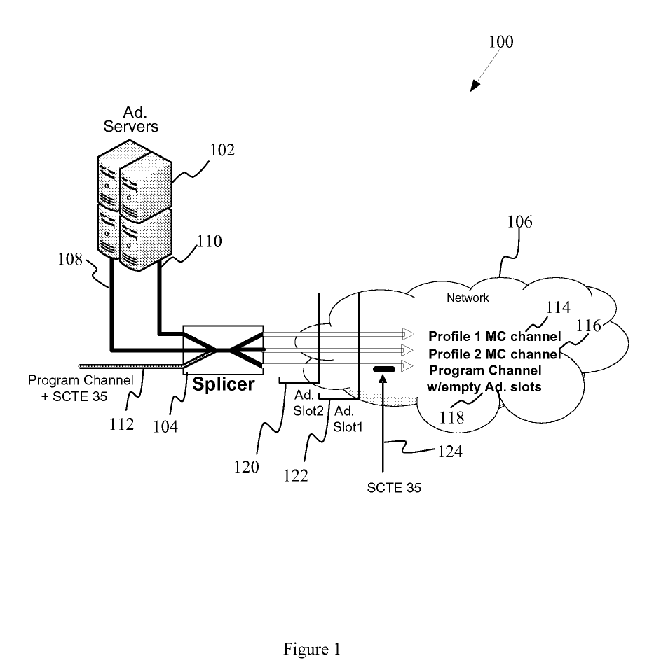

Now referring to FIG. 1, a system 100 comprises advertisement servers 102 and an advertisement splicer 104 coupled to a network 106. The advertisement servers 102 will inject several advertisements 108 and 110 relevant to a set of user profiles into multiple multicast channels 114 and 116 synchronized to a first and a second single advertisement slot 120 and 122 as indicated by SCTE 35 signaling 124 accompanying the program stream 112. More than one advertisement is able to be inserted into an ad slot 120 and 122. The program stream 112 will be empty 122 during the duration of the advertisement. By configuration, profile, or other criteria, the SCTE 35 triggers the end device to join a particular multicast advertisement stream of interest.

The advertisement splicer 104 may also remove any content or the default advertisement from the program stream if bandwidth, processing, or other similar constraints exist in the network. The removed advertisement could be placed in yet another multicast stream. The program stream will be empty during the duration of the ad which will enable seamless mixing with no special effort at an access node (described further below). The SCTE 35 signaling is forwarded in the Moving Picture Experts Group 2 (MPEG2) timeslot to a Set Top Box (STB) to inform the STB (described further below) of an imminent ad slot.

The described and depicted blocks or modules of the system 100 are at least one of: software, hardware, and firmware, and/or the combination of at least two of: software, hardware, and firmware. The transfer of data between the various blocks or modules in the system 100 occurs via at least one of a wireless protocol, a wired protocol, and a combination of a wireless protocol and a wired protocol. The steps performed in the system 100 are performed by at least one of: software, hardware, and firmware, and/or the combination of software, hardware, and/or firmware. Additionally, at least one of the various blocks or modules in the system 100 may form a circuit.

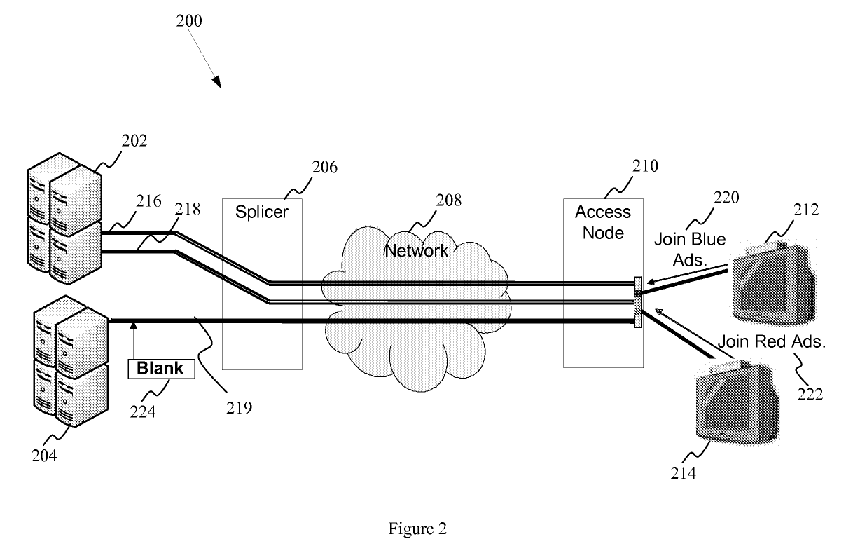

Referring now to FIG. 2, a system 200 comprises advertisement servers 202, program servers 204, an advertisement splicer 206, a network 208, an access node (AN) 210, and Set Top Boxes (STB) 212 and 214 are depicted. Advertisements are sent from one or more of the advertisement servers 202 to the splicer 206 via advertisement streams 216 and 218. Program content is sent from one or more of the program servers 204 to the splicer 206 via a program channel 219. One or more blank slots 224 are inserted into the program content for receipt by the splicer 206. The splicer 206 synchronizes the advertisement multicast channels 216 and 218 with the blank slot 224 of the program content and sends the synchronized stream through the network 208 (which may be a data network such as the Internet) to an access node 210.

The splicer 206 splices multiple advertisement streams into multiple multicast streams, leaving a gap in the program stream for the duration of the advertisement. By configuration, profile, or other criteria, the SCTE 35 triggers one or more of the STBs 212 and 214 to join a particular multicast advertisement stream of interest 216 and 218. The STBs 212 and 214 send an Internet Group Management Protocol (IGMP) join message 220 and 222 to the AN 210 to allow one or more of the STBs 212 and 214 to join to a particular multicast or unicast advertisement stream. The AN 210 treats this IGMP join as a normal join and performs an IGMP proxy function, but does not remove the original program multicast channel 224 from its multicast forwarding table (not shown) which associates synchronized advertisement streams (or output) with an entry in the table.

Multicast streams corresponding to all multicast group entries in the multicast forwarding table are forwarded to the STBs 212 and 214. The multicast forwarding table in the AN 210 assigns the advertisement multicast stream addresses 216 and 219 to their respective customer ports. The STBs 212 and 214 treat the advertising content 216 and 218 arriving in a different IP multicast or unicast group as belonging to the original program stream 219 and decodes and displays the content accordingly. Content streams are delivered to the AN 210, and the STB 212 and 214 access some or all of the content based on end user preference. The content appears as a single program (or a single aggregate channel) to the end user.

In one embodiment of the present invention, a third party call control may be present, where content is initiated or selected, and that maps which advertisement content stream to be delivered to the STBs. In another embodiment of the present invention, the synchronizing of the advertisement stream and the program content can occur at one or more of the advertisement servers 202, one or more of the program servers 204, the splicer 206, the AN 210, the STBs 212 and 214, or a combination of at least two of these blocks or modules.

The described and depicted blocks or modules of the system 100 are at least one of: software, hardware, and firmware, and/or the combination of at least two of: software, hardware, and firmware. The transfer of data between the various blocks or modules in the system 100 occurs via at least one of a wireless protocol, a wired protocol, and a combination of a wireless protocol and a wired protocol. The steps performed in the system 100 are performed by at least one of: software, hardware, and firmware, and/or the combination of software, hardware, and/or firmware. Additionally, at least one of the various blocks or modules in the system 100 may form a circuit.

In one embodiment of the present invention, a system for advertisement and content distribution comprises a splicer, and a set top box (STB), wherein the splicer is communicably coupled to the STB, wherein the splicer receives content, wherein the splicer receives at least one advertisement, wherein the splicer synchronizes the at least one advertisement on a first address with a slot in the content on a second address to produce an output, wherein the splicer sends the output to the STB, and wherein the STB displays the output. Referring again to the system, the first address and the second address are at least one of: a multicast channel and a unicast channel, wherein at least one of the STB and the splicer is informed of an approaching advertisement based on an SCTE 35 message, wherein the output is sent based on at least one of: a viewer profile, a viewer interest, a viewer configuration (for example a time of day, day of the week, specific STB, and the like), a type of the content, and a network configuration (for example, configured for local or foreign uses or preferences).

Within the system, the content can include more than one slot that can be synchronized with more than one of the at least one advertisement, wherein the splicer, and the STB are communicably coupled via at least one of: a network, and a direct connection, wherein the network can be one of: a data network, a wired network, and a wireless network, wherein an Access Node (AN) is communicably coupled to the splicer and the STB, wherein the AN includes a Digital Subscriber Line Access Module (DSLAM) that sends, to the STB, at least one of: the at least one advertisement, the content, and the output, wherein the DSLAM includes a Multicast Forwarding Table (MFT), wherein the MFT stores the output and wherein the STB selects the output, wherein the splicer sends, based on the specific multicast address, at least one of: the at least one advertisement, the content, and the output, wherein the splicer sends, based on a profile of a viewer, at least one of: the at least one advertisement, the content, and the output, wherein the viewer is associated with at least one of: the STB, and an advertiser.

Referring again to the system, at least a first server is communicably coupled to the splicer, and wherein the at least one server sends the at least one advertisement to the splicer, wherein at least a second server is communicably coupled to the splicer, and wherein the at least one server sends the content to the splicer, and wherein the at least one first server and the at least one second server are at least one of: a same server, and a different server.

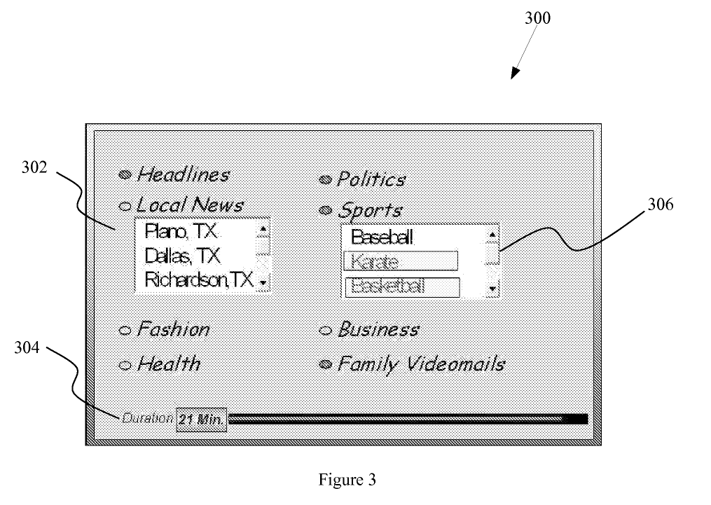

Referring now to FIG. 3, a graphical user interface (GUI) 300 that a user of the system can use to customize their viewing and hearing experience. The GUI 300 can be accessed by the user via an electronic device connected to the Internet or connected to the STB, for example. The user will have the availability to configure the system 100 and 200 to deliver local news from a specific city in a list 302, to input sports of interest from a list 306, as well as other selections such as headline news, politics, fashion, health, business, video, videomails, and the like. The duration of the content and/or a length of the content can also be configured 304. The system 100 and 200 will deliver content to the user that reflects the selections input on the GUI.

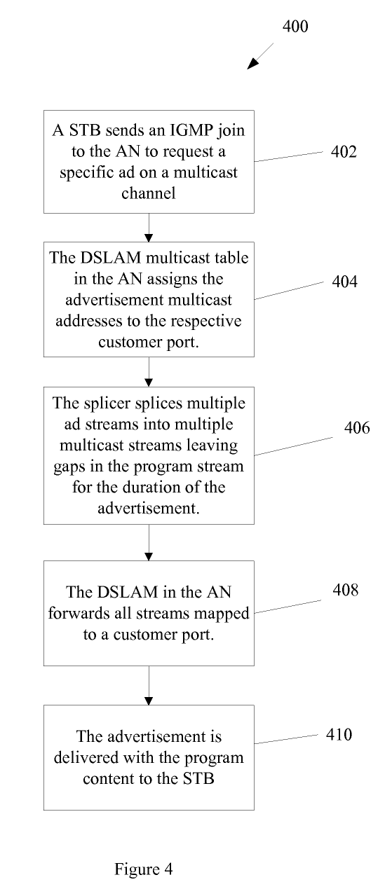

Referring now to FIG. 4, a flowchart 400 describing advertisement and content distribution is depicted. The flowchart begins at step 402 when a Set Top Box (STB) sends an IGMP join message to an Access Node (AN) to request a specific advertisement to be delivered via a multicast channel (in other embodiments, the advertisement can be delivered on a non-multicast channel). In step 404, a Digital Subscriber Line Access Module (DSLAM) multicast table inside the AN assigns the advertisement multicast addresses to a respective end user or customer port. In step 406, the advertisement splicer splices the multiple incoming advertisement streams leaving the incoming blank slots or gaps in the program content that will exist for the duration of the displayed advertisement. In step 408, the DSLAM in the AN forwards all incoming streams and content that were previously mapped to their respective customer ports. In step 410, the advertisement content is delivered to the user via the STB during the empty slot in the program content.

Although the steps related to FIG. 4 were described in a specific order, these steps can occur in any order or some of these steps may be omitted without departing from the scope of the present invention. The described and depicted steps of FIG. 4 performed by at least one of: software, hardware, and firmware, and/or the combination of at least two of: software, hardware, and firmware. The transfer of data described in the steps occurs via at least one of a wireless protocol, a wired protocol, and a combination of a wireless protocol and a wired protocol.

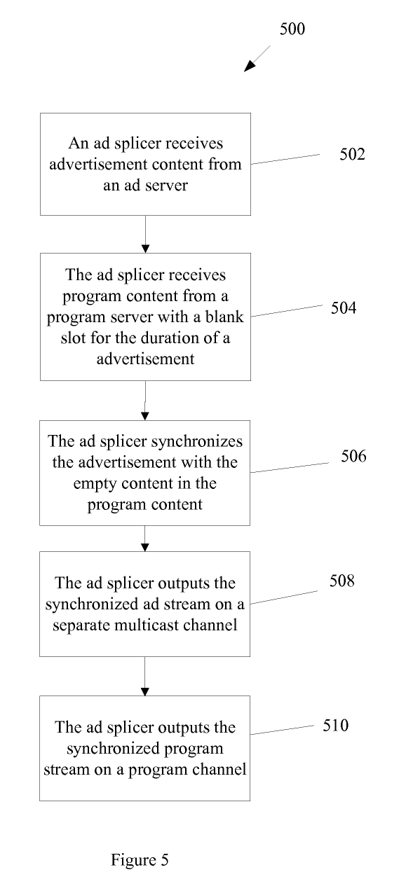

Referring now to FIG. 5, a flowchart 500 describing advertisement and content distribution is depicted. The flowchart begins at step 502, when an advertisement splicer receives advertisement content from one or more advertisement servers. In step 504, the advertisement splicer receives program content from a program server containing a blank slot that is equivalent (or nearly equivalent) to the length of an advertisement (or two or more advertisements). In step 506, an advertisement splicer synchronizes the advertisement with the empty slot in the program content. In step 508, the advertisement splicer outputs the synchronized advertisement content on a separate advertisement multicast channel. In step 510, the ad splicer outputs the program content on the program channel with the empty slot synchronized to the advertisement content that is output on the advertisement multicast channel.

Although the steps related to FIG. 5 were described in a specific order, these steps can occur in any order or some of these steps may be omitted without departing from the scope of the present invention. The described and depicted steps of FIG. 5 performed by at least one of: software, hardware, and firmware, and/or the combination of at least two of: software, hardware, and firmware. The transfer of data described in the steps occurs via at least one of a wireless protocol, a wired protocol, and a combination of a wireless protocol and a wired protocol.

In one embodiment of the present invention, a method for distributing an advertisement and content comprises receiving a content stream on a first channel, wherein the content includes an empty slot, sending a message, receiving a specific advertisement on the second channel based on the message decoding the received content and the received specific advertisement, and displaying the decoded content and advertisement. The method also comprises joining a plurality of channels, forming a plurality of streams converged into a synchronized channel.

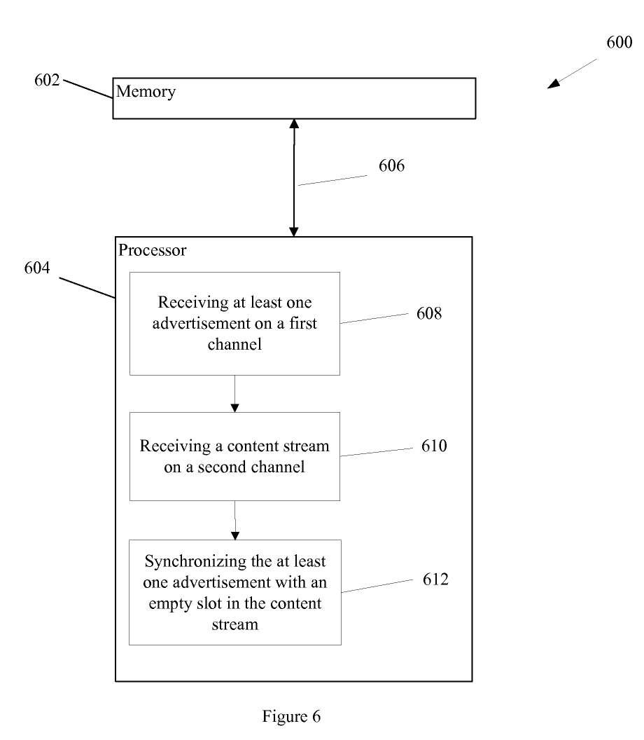

Referring now to FIG. 6, a system 600 for advertisement and content distribution is depicted. The system 600 is comprised of a memory 602 communicably coupled 606 to a processor 604. The processor 604 processes software or a computer readable medium that comprises instructions for: receiving at least one advertisement on a first channel, receiving a content stream on a second channel, and synchronizing the at least one advertisement with an empty slot in the content stream. The computer readable medium also comprises receiving a message (such as an SCTE message) wherein the synchronizing is based on the message.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A system for advertisement and content distribution, comprising:
a splicer; and
a set top box (STB);
wherein the splicer is communicably coupled to the STB;
wherein the splicer receives content;
wherein the splicer receives at least one advertisement;
wherein the splicer synchronizes the at least one advertisement on a first address with a slot in the content on a second address to produce an output;
wherein the splicer sends the output to the STB; and
wherein the STB displays the output.

2. The system of claim 1, wherein the first address and the second address are at least one of:
a multicast channel; and
a unicast channel.

3. The system of claim 1, wherein at least one of the STB and the splicer is informed of an approaching advertisement based on an SCTE 35 message.

4. The system of claim 3, wherein the output is sent based on at least one of:
a viewer profile;
a viewer interest;
a viewer configuration;
a type of the content; and
a network configuration.

5. The system of claim 1, wherein the content can include more than one slot that can be synchronized with more than one of the at least one advertisement.

6. The system of claim 1, wherein the splicer, and the STB are communicably coupled via at least one of:
a network; and
a direct connection.

7. The system of claim 6, wherein the network can be one of:
a data network;
a wired network; and
a wireless network.

8. The system of claim 1, wherein an Access Node (AN) is communicably coupled to the splicer and the STB.

9. The system of claim 8, wherein the AN is a Digital Subscriber Line Access Module (DSLAM) that sends, to the STB, at least one of:
the at least one advertisement;
the content; and
the output.

10. The system of claim 9, wherein the DSLAM includes a Multicast Forwarding Table (MFT).

11. The system of claim 10, wherein the MFT stores the output and wherein the STB selects the output.

12. The system of claim 11, wherein the splicer sends, based on the specific multicast address, at least one of:
the at least one advertisement;
the content; and
the output.

13. The system of claim 11, wherein the splicer sends, based on a profile of a viewer, at least one of:
the at least one advertisement;
the content; and
the output;
wherein the viewer is associated with at least one of: the STB, and an advertiser.

14. The system of claim 1, wherein at least a first server is communicably coupled to the splicer, and wherein the at least one server sends the at least one advertisement to the splicer.

15. The system of claim 14, wherein at least a second server is communicably coupled to the splicer, and wherein the at least one server sends the content to the splicer.

16. The system of claim 15, wherein the at least one first server and the at least one second server are at least one of:
a same server; and
a different server.

17. A method for distributing an advertisement and content, comprising:
receiving a content stream on a first channel, wherein the content includes an empty slot;
sending a message;
receiving a specific advertisement on the second channel based on the message;
decoding the received content and the received specific advertisement; and
displaying the decoded content and advertisement.

18. The method of claim 17 comprising joining a plurality of channels, forming a plurality of streams converged into a synchronized channel.

19. A computer readable medium comprising instructions for:
receiving at least one advertisement on a first channel;
receiving a content stream on a second channel; and
synchronizing the at least one advertisement with an empty slot in the content stream.

20. The computer readable medium of claim 19 comprising instructions for receiving a message wherein the synchronizing is based on the message.
